(19) United States
(12) Patent Application Publication
(10) Pub. No.: US 2017/0061183 A1
(43) Pub. Date: Mar. 2, 2017

(54) ANTI-COUNTERFEIT READER

(71) Applicants: JOHN M. HOUSTON, MILLERS POINT (AU); WEI P. WANG, BEIJING (CN)

(72) Inventors: JOHN M. HOUSTON, MILLERS POINT (AU); WEI P. WANG, BEIJING (CN)

(21) Appl. No.: 15/243,191

(22) Filed: Aug. 22, 2016

(30) Foreign Application Priority Data
Aug. 25, 2015 (CN) 201530322037.1
Sep. 29, 2015 (CN) 201520763454.4

(51) Int. Cl. G06K 7/12; G06K 19/06; G06Q 30/00; G06K 7/10

(52) U.S. Cl. CPC G06K 7/12; G06K 7/10564; G06K 19/0614; G06Q 30/0185

(57) ABSTRACT

A novel and practical on-the-go (OTG) USB-compatible anti-counterfeit reader with an emitter circuit that outputs a first signal to an object under test that will emit a second signal, and a receiver circuit that will detect the second signal and converts it to an electric signal to be further analyzed is disclosed. The emitter and receiver circuits are in electronic communication with a control and identification circuit which controls the emitter output duration and intensity and includes programming logic to authenticate the object under test based on the specific reading of the electric signal received. An interface conversion circuit is in communication with the control and identification circuit and is configured for level conversion of data between the control and identification circuit and an interface. A method of utilizing an OTG, USB-compatible anti-counterfeit reader to quickly and efficiently authenticate products is also provided.

This non-provisional patent application claims all benefits under 35 U.S.C. §119(e) of pending Chinese patent application No. 201520763454.4, entitled “OTG Anti-Counterfeit Scanner”, filed 29 Sep. 2015 at the State Intellectual Property Office of the People's Republic of China, and pending Chinese patent application No. 201530322037.1, entitled “Portable Anti-Counterfeit Scanner (OTG)”, filed 25 Aug. 2015 at the State Intellectual Property Office of the People's Republic of China, which are each incorporated by reference in their entirety herein.

### FIELD OF THE INVENTION

The invention herein pertains to anti-counterfeit devices and particularly pertains to an anti-counterfeit reader that transmits and receives fluorescent signals in determining the authenticity of a given product or document.

### DESCRIPTION OF THE PRIOR ART AND OBJECTIVES OF THE INVENTION

Optical scanners are known to be used in connection with the authentication of documents and products, particularly by businesses seeking to protect valuable brands, markets, and the interests and expectations of consumers. These scanners often attempt to authenticate products by relying on the detection of a signal, for example a chemical or fluorescent signal, embedded therein that only exists in a specific range of detection and is challenging to replicate. Further, the prior art devices are typically heavy, bulky, and expensive, and are therefore not well-suited for mobile use.

Thus, in view of the problems and disadvantages associated with prior art devices, the present invention was conceived and one of its objectives is to provide an anti-counterfeit reader that requires no external power source.

It is another objective of the present invention to provide an anti-counterfeit reader that does not require the object being authenticated to be moved, avoiding damage and contamination and permitting the ability to test objects at will.

It is still another objective of the present invention to provide an anti-counterfeit reader based upon Stokes and Anti-stokes movements with an excitation circuit that outputs a first signal to the object under test which emits a second fluorescent, infrared or combination of signals (i.e. the emission signal) when excited.

It is yet another objective of the present invention to provide an anti-counterfeit reader with a receiver circuit configured to receive the emission signal and converts it into an electric signal.

It is a further objective of the present invention to provide an anti-counterfeit reader with a control and identification circuit that is in electronic communication with the emitter and reader circuits to control the output duration and intensity of the emitter circuit and intensity and includes programming logic to authenticate the object under test based on the specific reading of the electric signal received.

It is still a further objective of the present invention to provide an anti-counterfeit reader with an interface conversion circuit in electronic communication with the control and identification circuit and a USB-compatible interface for level conversion of data therebetween.

It is yet a further objective of the present invention to provide an anti-counterfeit reader with a USB-compatible interface configured to output the authenticity data derived from the object under test received by the control and identification circuit and level-converted by the interface conversion circuit, for example to a user.

It is another objective of the present invention to provide an anti-counterfeit reader with a separate signal processing circuit that is in electronic communication with the receiver circuit for processing the electric signal.

It is still another objective of the present invention to provide an anti-counterfeit reader with a signal processing circuit including a primary signal processing sub-circuit for amplifying the electric signal output by the receiver circuit and a secondary signal processing sub-circuit for amplifying and filtering the electric signal output by the primary signal processing sub-circuit.

It is yet another objective of the present invention to provide an anti-counterfeiting reader with a compensation circuit in electronic communication with the primary signal processing sub-circuit and receiver circuit for compensating for any variation in ambient light.

It is a further objective of the present invention to provide an anti-counterfeit reader with a primary signal processing sub-circuit and a compensation circuit that are electronically connected and controlled by the control and identification circuit.

It is a still further objective of the present invention to provide an anti-counterfeit reader with a power supply circuit connected with the USB-compatible interface. The power supply circuit provides primary, secondary and tertiary power supplies for powering the mobile anti-counterfeit reader.

It is yet a further objective of the present invention to provide an anti-counterfeit reader with a primary power supply provided by an external electronic device via the USB-compatible interface. The power supply circuit converts the primary power supply to a tertiary power supply.

It is another objective of the present invention to provide an anti-counterfeit reader with an emitter circuit including infrared light-emitting diode D3, resistor R2, resistor R5, resistor R6, resistor R7, resistor R22, triode D2 and capacitor E1. One end of the resistor R6 is connected to the control and identification circuit, while the other end is connected to the base of the triode D2. The collector of the triode D2 is connected to the anode of the primary power supply via infrared diode D3 and resistor R22 which are serially connected. The two ends of the infrared diode D3 are connected in parallel and connected to resistor R2. The base of the triode D2 is connected to the ground via resistor R5, while its emitter is connected to the ground via resistor R7. The cathode of capacitor E1 is connected to the ground, while its anode is connected to the anode of the primary power supply via resistor R22.

It is still another objective of the present invention to provide an anti-counterfeit reader with a receiver circuit including infrared light-receiving diode D4, operational amplifier U2B, resistor R11, resistor R9, capacitor C12, capacitor C9 and diode D5. The cathode of the infrared light-receiving diode D4 is connected to the anode of the tertiary power supply via resistor R11, and connected to the ground via capacitor C12. The anode of the infrared light-receiving diode D4 is connected to the inverting input of the operational amplifier. The inverting input of the operational amplifier U2B is connected to the output of the operational amplifier U2B via resistor R9, diode D5 and capacitor C9 which are connected in parallel. The non-inverting input of the operational amplifier U2B is connected to the ground.

It is yet another objective of the present invention to provide an anti-counterfeit reader with an interface conversion circuit including RS232-USB interface converter U3, resistor R18, resistor R19, resistor R20 and resistor R21. Pin DP of the RS232-USB interface converter U3 is connected to the D+ end of the USB-compatible interface via resistor R19. Pin DM of the RS232-USB interface converter U3 is connected to the D− end of the USB-compatible interface via resistor R21. The D+ end of the USB-compatible interface is connected to the anode of the secondary power supply via resistor R21. Pin RXD and pin TXD of the RS232-USB interface converter U3 are connected to the control and identification circuit. Pin of the RS232-USB interface converter U3 is connected to the anode of the secondary power supply via resistor R18.

It is a further objective of the present invention to provide an anti-counterfeit reader with a primary signal processing sub-circuit including resistor R17, resistor R10, operational amplifier U2C and capacitor C10. One end of the resistor R17 is connected to the output of the receiver circuit, while the other end is connected to the inverting input of operational amplifier U2C. Resistor R10 and capacitor C10 are connected in parallel between the inverting input and output of the operational amplifier U2C. The non-inverting input of the operational amplifier is connected to the ground.

It is still a further objective of the present invention to provide an anti-counterfeit reader with a secondary signal processing sub-circuit including operational amplifier U2D, capacitor C13, capacitor C18, capacitor C11, resistor R16, resistor R12, resistor R14 and resistor R13. The resistor R16 and capacitor C18 constitutes a RC filter circuit. One end of resistor R16 is connected to the output of the primary signal processing sub-circuit, while the other end is connected to the non-inverting input of operational amplifier U2D, and connected to the ground via capacitor C18. The inverting input of the operational amplifier U2D is connected to the ground via resistor R12. Resistor R14 and capacitor C11 are connected in parallel between the inverting input and output of the operational amplifier U2D. The RC filter circuit composed of the operational amplifier U2D, resistor R13 and capacitor C13 are connected to the control and identification circuit.

It is yet a further objective of the present invention to provide an anti-counterfeit reader with a compensation circuit including analog switch U1, operational amplifier U2A, resistor R8, resistor R15 and capacitor C8. Pin D of the analog switch is connected to the output of the primary signal processing sub-circuit via resistor R15. Pin IN of the analog switch is connected to the control and identification circuit. Pin Si of the analog switch is connected to the inverting input of the operational amplifier U2A. The capacitor C8 is between the inverting input and output of the operational amplifier U2A. The non-inverting input of the operational amplifier U2A is connected to the ground. The output of the operational amplifier U2A is connected to the receiver circuit via resistor R8. Pin VL and pin V+ of the analog switch are connected to the anode of the tertiary power supply. Pin GND of the analog switch is connected to the ground. Pin V− of the analog switch is connected to the cathode of the tertiary power supply.

It is another objective of the present invention to provide an anti-counterfeit reader with a power supply circuit including resistor R1, resistor R3, resistor R4, capacitor C3, capacitor C4, capacitor C5, capacitor C6, capacitor C7, capacitor C15, inductor G1 and diode D1. The diode D1 integrates two diodes. The cathode of one diode is connected to the anode of the other. One end of resistor R3 is connected to the control and identification circuit, while the other end is connected to the common end of the diode D1 via capacitor C. The anode of the diode D1 is connected to one end of resistor R1, and connected to the ground via capacitor C6. The other end of the resistor R1 serves as the cathode of the tertiary power supply, and is connected to the ground via capacitor C4. The cathode of the diode D1 is connected to the ground. One end of the inductor is connected to the VBUS end of the USB-compatible interface, while the other end serves as the anode of the primary power supply, and is connected to the ground via capacitor C7. Resistor R4 and capacitor C5 constitute a RC filter circuit. One end of resistor R4 is connected to the anode of the primary power supply, while the other end serves as the anode of the tertiary power supply, and is connected to the ground via capacitor C5.

It is still another objective of the present invention to provide an anti-counterfeit reader with a Mini-A interface configured for communication with the USB-compatible interface, with the ID end of the USB-compatible interface connected to the ground. Alternatively, a Mini-B interface may be used as the USB-compatible interface, with the ID end of the USB-compatible interface suspended.

Various other objectives and advantages of the present invention will become apparent to those skilled in the art as a more detailed description is set forth below.

### SUMMARY OF THE INVENTION

The aforesaid and other objectives are realized by providing an On-The-Go (“OTG”) anti-counterfeit substrate reader that is USB-compatible with mobile computing devices such as tablet computers and “smart” mobile phones. The novel reader includes an emitter circuit that outputs a first signal to an object under test that will emit an emission signal when excited, and a receiver circuit that will detect the emission signal and converts it to an electric signal to be further analyzed. The emitter and receiver circuits are in electronic communication with a control and identification circuit which controls the emitter output duration and intensity and includes programming logic to authenticate the object under test based on the specific reading of the electric signal received. An interface conversion circuit is in communication with the control and identification circuit and is configured for level conversion of data between the control and identification circuit and a USB-compatible interface. Once authenticity is confirmed, the reader also includes a USB-compatible interface configured to output the authenticity data derived from the object under test received by the control and identification circuit and level-converted by the interface conversion circuit, for example to a user.

### BRIEF DESCRIPTION OF THE DRAWINGS

FIG. 1 shows a schematic block diagram of a preferred embodiment of the instant anti-counterfeit reader, and

FIG. 2 pictures a circuit diagram of the anti-counterfeit reader of FIG. 1.

### DETAILED DESCRIPTION OF THE PREFERRED EMBODIMENT AND OPERATION OF THE INVENTION

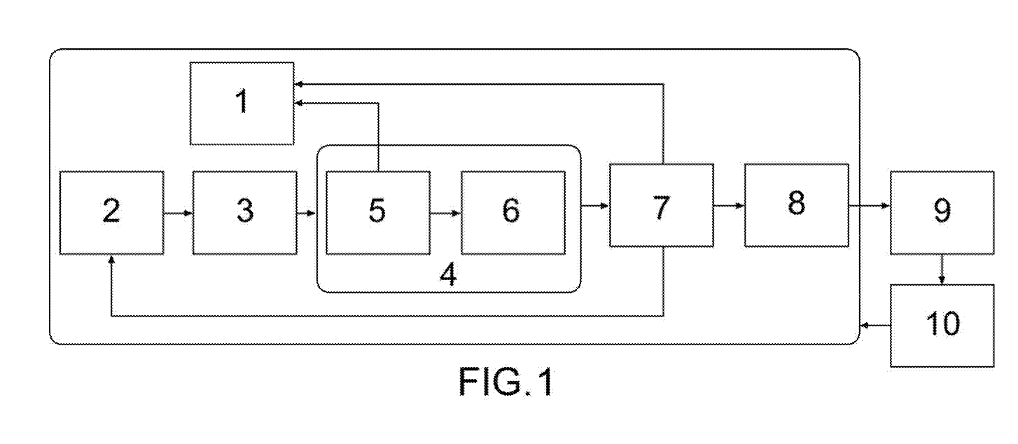

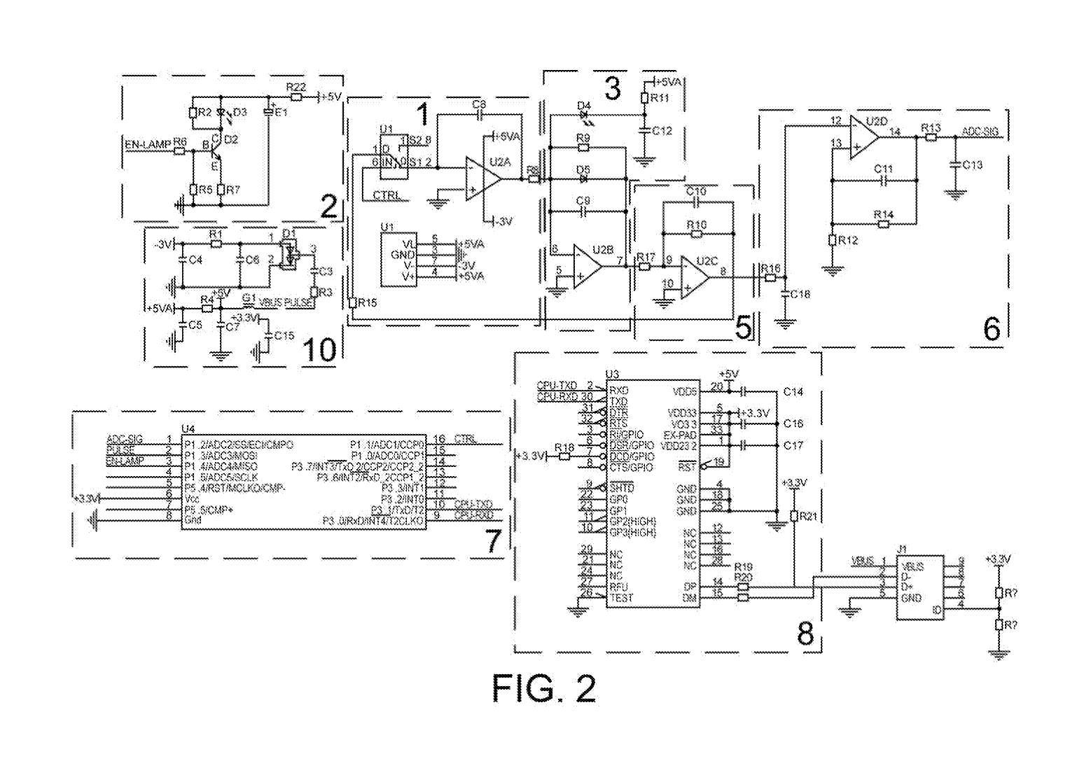

The purpose, technical solutions, and benefits of the new invention will be clearly and completely described below in combination with FIGS. 1-2. The examples below are only part, but not all of its implementation examples. All other examples obtained by ordinary technicians in the field without making any creative efforts will also be covered within the protection scope of the invention.

As shown in FIG. 1 and FIG. 2, the OTG anti-counterfeiting reader 10 includes an emitter circuit 2 that outputs a first excitation signal (for example, a first fluorescence signal) to the object under test (not shown) which will emit a first emission signal (for example, a second fluorescence signal, preferably different from the first fluorescence signal) when excited by the first signal, a receiver circuit 3 that receives the first emission signal and converts it to an electric signal, a control and identification circuit 7 that is connected to emitter and receiver circuits 2, 3, to control the output of the emitter circuit 2 and authenticate the object under test based on the electric signal, an interface conversion circuit 8 that is connected to the control and identification circuit 7 and interface 9 for level conversion of the data between them. The preferred interface with respect to interface 9 is a USB interface configured to output the authenticity data of the object under test received by the control and identification circuit 7 and level-converted by the interface conversion circuit 8. However, it should be recognized that other compatible I/O interfaces such as A/V interfaces (i.e. speakers, video, and the like), mini USB interfaces, Lightning connectors, and wireless interface configurations such as Bluetooth™, WiFi, and other wireless technologies (for example near-field communication) are also considered and thus within the scope of the instant disclosure. The implication of this breadth is to avoid any limitation to a single manufacturer, equipment provider, or operating system. As such, software such as iOS and/or Android operating systems are intended to operate with equal compatibility when associated with OTG anti-counterfeiting reader 10. Anti-counterfeit reader 10 also preferably includes signal processing circuit 4 that is connected to, and in electronic communication with, receiver circuit 3 for processing the electric signal. Furthermore, the signal processing circuit 4 may include primary signal processing sub-circuit 5 for amplifying the electric signal output by the receiver circuit 3 and secondary signal processing sub-circuit 6 for amplifying and filtering the electric signal output by the primary signal processing sub-circuit 5. Anti-counterfeit reader 10 may also include a compensation circuit 1 between the primary signal processing sub-circuit 5 and receiver circuit 3 for compensating for variability in the ambient light present at the time and place of the authentication test. Regardless whether the primary signal processing sub-circuit 5 and the compensation circuit 1 are in direct electronic communication, they are both preferably controlled by control and identification circuit 7. In addition, anti-counterfeit reader 10 also preferably includes a power supply circuit 10 connected with the USB-compatible interface 9. The power supply circuit 10 provides communication to the primary, secondary and tertiary power supplies (not shown) for powering anti-counterfeit reader 10. In an embodiment, the primary power supply is provided by an external electronic device such as an external battery (not shown) and in connected to the anti-counterfeit reader 10 via USB-compatible interface 9 as demonstrated in FIG. 1. The power supply circuit 10 is capable of converting the primary power supply to a tertiary power supply as will be clear following the description below.

The emitter circuit 2 preferably includes infrared light-emitting diode D3, resistor R2, resistor R5, resistor R6, resistor R7, resistor R22, triode D2 and capacitor E1 as shown in FIG. 2. One end of the resistor R6 is connected to the control and identification circuit 7, while the other end is connected to the base of the triode D2. The collector of the triode D2 is connected to the anode of the primary power supply via infrared diode D3 and resistor R22 which are preferably connected in serial. The two ends of the infrared diode D3 are connected, preferably in parallel, and then are connected to resistor R2. The base of the triode D2 is connected to the ground via resistor R5, while its emitter is connected to the ground via resistor R7. The cathode of capacitor E1 is connected to the ground, while the anode is connected to the anode of the primary power supply via resistor R22.

The receiver circuit 3 preferably includes infrared light-receiving diode D4, operational amplifier U2B, resistor R11, resistor R9, capacitor C12, capacitor C9 and diode D5. The cathode of the infrared light-receiving diode D4 is connected to the anode of the tertiary power supply via resistor R11, and connected to the ground via capacitor C12. The anode of the infrared light-receiving diode D4 is connected to the inverting input of the operational amplifier. The inverting input of the operational amplifier U2B is connected to the output of the operational amplifier U2B via resistor R9, diode D5 and capacitor C9 which are connected, preferably in parallel. The non-inverting input of the operational amplifier U2B is connected to the ground.

The interface conversion circuit 8 is preferably RS232-USB interface converter U3 with resistor R18, resistor R19, resistor R20 and resistor R21, although other interface conversion circuits consistent with the type of interfaces as described above are within the scope of interface conversion circuit 8. Pin DP of the RS232-USB interface converter U3 is connected to the D+ end of the USB-compatible interface 9 via resistor R19. Pin DM of the RS232-USB interface converter U3 is connected to the D− end of the USB-compatible interface 9 via resistor R21. The D+ end of the USB-compatible interface 9 is connected to the anode of the secondary power supply via resistor R21. Pin RXD and pin TXD of the RS232-USB interface converter U3 are connected to the control identification circuit 7. Pin of the RS232-USB interface converter U3 is connected to the anode of the secondary power supply via resistor R18.

Signal processing circuit 4 preferably includes primary signal processing sub-circuit 5 including resistor R17, resistor R10, operational amplifier U2C, and capacitor C10. One end of the resistor R17 is connected to the output of the receiver circuit 3, while the other end is connected to the inverting input of operational amplifier U2C. Resistor R10 and capacitor C10 are connected, preferably in parallel, between the inverting input and output of the operational amplifier U2C. The non-inverting input of the operational amplifier is connected to the ground. Signal processing circuit 4 also preferably includes secondary signal processing sub-circuit 6 with operational amplifier U2D, capacitor C13, capacitor C18, capacitor C11, resistor R16, resistor R12, resistor R14 and resistor R13. The resistor R16 and capacitor C18 constitutes a RC filter circuit. One end of resistor R16 is connected to the output of the primary signal processing sub-circuit 5, while the other end is connected to the non-inverting input of operational amplifier U2D, and connected to the ground via capacitor C18. The inverting input of the operational amplifier U2D is connected to the ground via resistor R12. Resistor R14 and capacitor C11 are connected, preferably in parallel, between the inverting input and output of the operational amplifier U2D. The RC filter circuit is preferably composed of the operational amplifier U2D, resistor R13 and capacitor C13 which are connected to the control and identification circuit 7.

The compensation circuit 1 preferably includes analog switch U1, operational amplifier U2A, resistor R8, resistor R15 and capacitor C8. Pin D of the analog switch is connected to the output of the primary signal processing sub-circuit 5 via resistor R15. Pin IN of the analog switch is connected to the control and identification circuit 7. Pin Si of the analog switch is connected to the inverting input of the operational amplifier U2A. The capacitor C8 is between the inverting input and output of the operational amplifier U2A. The non-inverting input of the operational amplifier U2A is connected to the ground. The output of the operational amplifier U2A is connected to the receiver circuit 3 via resistor R8. Pin VL and pin V+ of the analog switch are connected to the anode of the tertiary power supply. Pin GND of the analog switch is connected to the ground. Pin V− of the analog switch is connected to the cathode of the tertiary power supply.

The power supply circuit 10 preferably includes resistor R1, resistor R3, resistor R4, capacitor C3, capacitor C4, capacitor C5, capacitor C6, capacitor C7, capacitor C15, inductor G1 and diode D1. The diode D1 integrates two diodes. The cathode of one diode is connected to the anode of the other. One end of resistor R3 is connected to the control and identification circuit 7, while the other end is connected to the common end of the diode D1 via capacitor C. The anode of the diode D1 is connected to one end of resistor R1, and connected to the ground via capacitor C6. The other end of the resistor R1 serves as the cathode of the tertiary power supply, and is connected to the ground via capacitor C4. The cathode of the diode D1 is connected to the ground. One end of the inductor is connected to the VBUS end of the USB-compatible interface 9, while the other end serves as the anode of the primary power supply, and is connected to the ground via capacitor C7. Resistor R4 and capacitor C5 constitutes a RC filter circuit. One end of resistor R4 is connected to the anode of the primary power supply, while the other end serves as the anode of the tertiary power supply, and is connected to the ground via capacitor C5.

An embodiment of anti-counterfeit reader 10 may utilize a Mini-A interface in place of, or in addition to the USB-compatible interface 9. This embodiment includes the ID end of the USB-compatible interface 9 connected to the ground, and when a Mini-B interface is used as the USB-compatible interface 9, the ID end of the USB-compatible interface 9 is suspended. Pin VDD5 of the RS232-USB interface converter U3 is connected to the anode of the primary power supply, and pin VDD33, pin VO33, pin EX-PAD, pin VDD232 and pin of the RS232-USB interface converter U3 are all connected to the anode of the secondary power supply. The capacitor C14 is connected, preferably in parallel, between the anode of the primary power supply and the ground, and the capacitor C16, capacitor C15 and capacitor C17 are connected, preferably in parallel, between the anode of the secondary power supply and the ground.

The preferred control and identification circuit 7 uses the single chip microcomputer (SCM) U4 with the chip model number STC15W401AS. The resistor R6 in the emitter circuit 2 is connected to pin P1.4 of the SCM U4, and when the control and identification circuit 7 outputs the control signal (EN-LAMP) of the emitter circuit 2 output first excitation signal, the infrared light-emitting diode D3 outputs the near-infrared light to the object under test, such as anti-counterfeiting materials, anti-counterfeiting marks, fake-proof marks, or the like (not shown). The object under test produces an emission that can be a stokes, anti-stokes or combination of both (for example, this first emission may be a near fluorescence signal) excited by the near infrared light, the infrared receiving diode D4 detects and receives the first emission signal and converts it through the receiver circuit 3 to the electric signal output corresponding to the first emission signal. The electric signal (ADC-SIG) output by the receiver circuit 3, after being amplified and filtered by the primary signal processing sub-circuit 5 and the secondary signal processing sub-circuit 6, is transmitted to SCM U4. The output of the secondary signal processing sub-circuit 6 is connected to pin P1.2 of SCM U4, which produces the authenticity result of the object under test according to the specifics of the electric signal received. The specific implementation is based on the existing technologies as would be understood by one of ordinary skill in the art. For more details, please refer to the relevant content on the Identification Devices, Methods, Article Authentication Systems and Methods submitted for patent application on Feb. 10, 2015 (Application Number: 201510071159.7, the contents of which are hereby incorporated by reference in its entirety), in which the specific technical implementation is released to judge whether there are any anti-counterfeiting marks (i.e. the authenticity result of the object under test can be obtained).

The control and identification circuit 7 can also determine the attribute of the object under test according to specific measurements associated with the electric signal, such as the signal's amplitude or frequency. The authenticity result of the object under test can be output via interface conversion circuit 8 and USB-compatible interface 9, in particular output directly to external electronic devices (not shown, but for example a mobile computing device) connected to USB-compatible interface 9. The authenticity result can be electronically store in memory of the mobile computing device, shown on the mobile computing device display screen, and/or given voice prompt through the mobile computing device speakers.

The SCM U4 serial port (pin RxD and pin TxD) is preferably connected to the interface conversion circuit 8. In addition, as the spectrum of external ambient light overlaps in part with the receiving spectrum of the receiver circuit 3, the anti-counterfeit reader is configured (i.e. includes hardware and/or software components) that filter out the interfering ambient light through the ambient light compensation circuit 1 to improve the testing accuracy. It is the control and identification circuit 7 that dictates whether the primary signal processing sub-circuit 5 is connected with the compensation circuit 1. Specifically, when the emitter circuit 2 does not emit a first signal, the control analog switch of the control and identification circuit 7 will be turned off, and feedback ambient light to the receiver circuit 3 to compensate for the interfering ambient light in the electrical light output by the receiver circuit, thereby eliminating the impact of the ambient light. In this new and more accurate method of anti-counterfeit testing, the primary power supply is preferably a 5V uni-polar input, the secondary power supply is preferably a 3.3 V uni-polar input, and the tertiary power supply is preferably a asymmetric bipolar input (+5VA on anode and -3V on cathode). The infrared light-emitting diode D3 is preferably IR333-A, the analog switch U1 is preferably DG419DY, and the operational amplifiers U2A, U2B, U2C and U2D are preferably MC33179. The anode of the power supply is connected to the anode of the tertiary power supply, and the cathode of the power supply is connected to the cathode of the tertiary power supply. The infrared receiving diode D4 is preferably PD333-3B-L2-HO, the diode D1 is preferably BAV99, the RS232-USB interface converter U3 is preferably PL-2303 HXD. As represented in the Figs., USB-compatible interface 9 may include either Mini-A interface or Mini-B interface.

Anti-counterfeit scanner 10 can apply to all places where on-site, damage-free, contactless and quick identification of commodities is required. Examples include when a consumer needs to identify the authenticity of commodities while shopping, specifically when a consumer buys drugs, cosmetics, alcohol, tobacco, medical devices, and other commodities in drug stores, supermarkets, shopping malls, and duty-free shops; or when a manufacturer needs to authenticate the products and raw materials procured, specifically when an enterprise buys from a third party medicines, equipment, raw materials, machinery products, instruments, meters, parts, semi-finished products, and raw materials, or when quality inspection and supervision departments need to identify the authenticity of the commodities within their jurisdiction, and when the state inspection agencies and quality supervision departments need to authenticate the commodities in the market within their jurisdiction.

As contemplated above, the external electronic devices with which the anti-counterfeit reader 10 may be connected via the USB-compatible interface 9, can be any computing device but preferably is a mobile computing device such as a tablet computer or mobile phones. The authenticity result of the object under test, provided by the anti-counterfeiting reader 10, can be displayed to users through the screen, sound, memory or other resources of external electronic devices (such as mobile phones).

Compared with existing technologies known in the prior art, the useful and novel anti-counterfeit reader significant benefits, including connection, via USB-compatible interface 9, to mobile computing devices such as mobile phones and other external electronic devices which can supply power to the reader, saving the trouble and expense of buying and maintaining extra batteries. The power use of external electronic devices has been widely recognized and they can be recharged anytime so that the normal use of anti-counterfeit reader 10 will not be affected. The anti-counterfeit reader 10 is simple in circuit structure and can be put in a portable case for practical mobile use. It is then adaptable, portable, and can quickly conduct contactless and damage-free on-site tests of the object under test without having to move the object, highly desirable in cases where the object is a delicate document or fragile member. It will be helpful to protect the unsold commodities, and solve the problem of some desktop anti-counterfeiting readers that cannot be used to test products any time at will. The anti-counterfeit reader 10 can provide users with convenient and effective testing methods, use mature mobile phone OTG model via USB-compatible interface 9, and enable man-machine interactions by using the sound, memory, display, and other resources of external electronic devices (such as mobile phones), expanding the ways of reporting the identification results, particularly when transmitting such results may be useful to more than the instant user.

The illustrations and examples provided herein are for explanatory purposes and are not intended to limit the scope of the appended claims.

We claim:

1. An anti-counterfeit reader comprising
an emitter circuit that outputs an excitation signal to an object under test which will emit an emission signal when excited by the excitation signal,
a receiver circuit that receives the emission signal and converts it to an electric signal,
a control and identification circuit that is connected and in electronic communication with the emitter and receiver circuits so as to control emitter output,
an interface connected to and in electronic communication with the control and identification circuit and an interface conversion circuit,
whereby the interface conversion circuit is configured for level conversion of data resulting from the electric signal, and
whereby the electric signal is analyzed to confirm or deny an authenticity result of the object under test via the control and identification circuit, and
whereby the interface outputs the authenticity result.

2. The anti-counterfeit reader of claim 1 further comprising a signal processing circuit that is connected to the receiver circuit for processing the electric signal.

3. The anti-counterfeit reader of claim 2 whereby the signal processing circuit further comprises a primary signal processing sub-circuit for amplifying the electric signal output by the receiver circuit, and a secondary signal processing sub-circuit for amplifying and filtering the electric signal output by the primary signal processing sub-circuit.

4. The anti-counterfeit reader of claim 3 further comprising a compensation circuit between the primary signal processing sub-circuit and receiver circuit for compensating based on ambient light.

5. The anti-counterfeit reader of claim 4 whereby the primary signal processing sub-circuit and the compensation circuit are connected and controlled by the control and identification circuit.

6. The anti-counterfeit reader of claim 1 further comprising a power supply circuit connected with the interface.

7. The anti-counterfeit reader of claim 6 whereby the power supply circuit is defined by primary, secondary and tertiary power supplies for powering the anti-counterfeit reader.

8. The anti-counterfeit reader of claim 7 whereby the primary power supply is defined by an external electronic device in communication with the interface, and whereby the power supply circuit converts the primary power supply to the tertiary power supply.

9. The anti-counterfeit reader of claim 7 whereby the emitter circuit further comprises
an infrared light-emitting diode D3, resistor R2, resistor R5, resistor R6, resistor R7, resistor R22, triode D2 and capacitor E1, whereby one end of the resistor R6 connected to the control and identification circuit and the other end connected to a base of the triode D2, and whereby the base of the triode D2 is connected to a ground via resistor R5, the an emitter connected to the ground via resistor R7, and
whereby a collector of the triode D2 is connected to an anode of the primary power supply via infrared diode D3 and resistor R22 which are connected in serial, and
whereby two ends of the infrared diode D3 are connected in parallel and then connected to resistor R2, and
whereby a cathode of capacitor E1 is connected to a ground, with an anode connected to an anode of the primary power supply via resistor R22.

10. The anti-counterfeit reader of claim 7 whereby the receiver circuit further comprises,
an infrared light-receiving diode D4, operational amplifier U2B, resistor R11, resistor R9, capacitor C12, capacitor C9 and diode D5, whereby a cathode of the infrared light-receiving diode D4 connected to an anode of the tertiary power supply via resistor R11, and connected to a ground via capacitor C12, and
whereby an anode of the infrared light-receiving diode D4 is connected to the inverting input of the operational amplifier, with the inverting input of the operational amplifier U2B connected to the output of the operational amplifier U2B via resistor R9, diode D5 and capacitor C9 which are connected in parallel, and
whereby the non-inverting input of the operational amplifier U2B is connected to a ground.

11. The anti-counterfeit reader of claim 7 whereby the interface conversion circuit further comprises,
a RS232-USB interface converter U3, resistor R18, resistor R19, resistor R20 and resistor R21, with a pin DP of the RS232-USB interface converter U3 connected to a D+ end of the USB-compatible interface via resistor R19, and a pin DM of the RS232-USB interface converter U3 connected to a D− end of the USB-compatible interface via resistor R21, and
whereby the D+ end of the USB-compatible interface is connected to an anode of the secondary power supply via resistor R21, with pin RXD and pin TXD of the RS232-USB interface converter U3 connected to the control and identification circuit, and with pin of the RS232-USB interface converter U3 connected to the anode of the secondary power supply via resistor R18.

12. The anti-counterfeit reader of claim 7 whereby the power supply circuit further comprises
resistor R1, resistor R3, resistor R4, capacitor C3, capacitor C4, capacitor C5, capacitor C6, capacitor C7, capacitor C15, inductor G1 and diode D1 integrating two diodes, with a cathode of one diode connected to an anode of the other diode, and an end of resistor R3 connected to the control and identification circuit, and an opposing end connected to a common end of the diode D1 via capacitor C, whereby an anode of the diode D1 is connected to one end of resistor R1, and connected to a ground via capacitor C6, and whereby an opposing end of the resistor R1 serves as a cathode of the tertiary power supply, and is connected to a ground via capacitor C4, and
whereby the cathode of the diode D1 is connected to a ground, with an end of the inductor connected to a VBUS end of the USB-compatible interface, and an opposing end as an anode of the primary power supply, connected to a ground via capacitor C7, and
whereby resistor R4 and capacitor C5 define a RC filter circuit, with an end of resistor R4 connected to an anode of the primary power supply, with an opposing end serving as an anode of the tertiary power supply, and connected to a ground via capacitor C5, with the capacitor C15 connected in parallel between the anode of the secondary power supply and the ground.

13. The anti-counterfeit reader of claim 3 whereby the primary signal processing sub-circuit further comprises resistor R17, resistor R10, operational amplifier U2C and capacitor C10, with an end of the resistor R17 connected to an output of the receiver circuit, and an opposing end connected to an inverting input of operational amplifier U2C, whereby resistor R10 and capacitor C10 are connected in parallel between the inverting input and output of the operational amplifier U2C, and whereby the non-inverting input of the operational amplifier is connected to a ground.

14. The anti-counterfeit reader of claim 3 whereby the secondary signal processing sub-circuit further comprises operational amplifier U2D, capacitor C13, capacitor C18, capacitor C11, resistor R16, resistor R12, resistor R14 and resistor R13, with resistor R16 and capacitor C18 defining a RC filter circuit, and with an end of resistor R16 connected to an output of the primary signal processing sub-circuit, and an opposing end connected to a non-inverting input of operational amplifier U2D, and connected to a ground via capacitor C18, whereby the inverting input of the operational amplifier U2D is connected to a ground via resistor R12, and whereby resistor R14 and capacitor C11 are connected in parallel between the inverting input and output of the operational amplifier U2D, and whereby the RC filter circuit composed of the operational amplifier U2D, resistor R13 and capacitor C13 is connected to the control and identification circuit.

15. The anti-counterfeit reader of claim 3 whereby the compensation circuit further comprises an analog switch U1, operational amplifier U2A, resistor R8, resistor R15 and capacitor C8, with a pin D of the analog switch connected to an output of the primary signal processing sub-circuit via resistor R15, and with a pin IN of the analog switch connected to the control and identification circuit, and with a pin Si of the analog switch connected to an inverting input of the operational amplifier U2A, whereby the capacitor C8 is between the inverting input and output of the operational amplifier U2A, and whereby the non-inverting input of the operational amplifier U2A is connected to a ground, and whereby the output of the operational amplifier U2A is connected to the receiver circuit via resistor R8, and whereby a pin VL and pin V+ of the analog switch are connected to an anode of a tertiary power supply, and whereby a pin GND of the analog switch is connected to a ground, and whereby a pin V− of the analog switch is connected to a cathode of the tertiary power supply.

16. The anti-counterfeit reader of claim 3 further comprising a Mini-A interface utilized as the interface, whereby an ID end of the interface is connected to a ground.

17. The anti-counterfeit reader of claim 3 further comprising a Mini-B interface utilized as the interface, whereby an ID end of the USB-compatible interface is suspended.
